(19) United States
(12) Patent Application Publication
(10) Pub. No.: US 2003/0029786 A1
(43) Pub. Date: Feb. 13, 2003

(54) Modular filter housing

(76) Inventors: Hans-Weddo Schmidt, Hardegsen (DE); Holger Linne, Gottingen (DE)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/188,261

(22) Filed: Jul. 1, 2002

(30) Foreign Application Priority Data
Aug. 8, 2001 (DE) DE 101 38 899.3

(51) Int. Cl. B01D 25/00

(52) U.S. Cl. 210/323.2

(57) ABSTRACT

A modular filter housing is disclosed, comprising two end caps (2, 4) and at least one tube-shaped intermediate section (6), one or more of which can be installed between the end caps (2, 4) in order to form a filter housing of adjustable length, wherein the intermediate sections (6) and the end caps (2, 4) are sealingly connected with one another.

### BACKGROUND OF THE INVENTION

In the realm of filter technology, various kinds of filter modules have been employed, e.g., spiral-wound modules for cross-flow filtration which are placed inside a filter housing. Such filter modules come in different dimensions and particularly in a variety of lengths, in order to make a specific filter surface area available for a desired application. A filter housing must be custom-made to accommodate filter modules of differing lengths, leading to increased costs in the manufacture of a filter system and to limitations on the adaptability of a given filter system.

Thus, there is a need in the art for a filter housing which is universally adaptable to accommodate filter modules of different lengths.

### BRIEF SUMMARY OF THE INVENTION

The present invention provides a modular filter housing comprising two end caps and at least one tubular intermediate section wherein at least one of the end caps is provided with openings for fluid inflow and outflow, and wherein the end caps and the intermediate section(s) are adapted to accommodate at least one filter module and to be sealingly joined to each other.

### BRIEF DESCRIPTION OF THE SEVERAL VIEWS OF THE DRAWINGS

FIG. 1 is a side view of an exemplary filter housing of the invention with one intermediate section.

FIG. 2 is a side view of an exemplary filter housing of the invention with two intermediate sections.

FIG. 3 is a top view of the end face of a first end cap of the housing of the invention.

FIG. 4 is a top view of the end face of a second end cap of the housing of the invention.

### DETAILED DESCRIPTION OF PREFERRED EMBODIMENTS

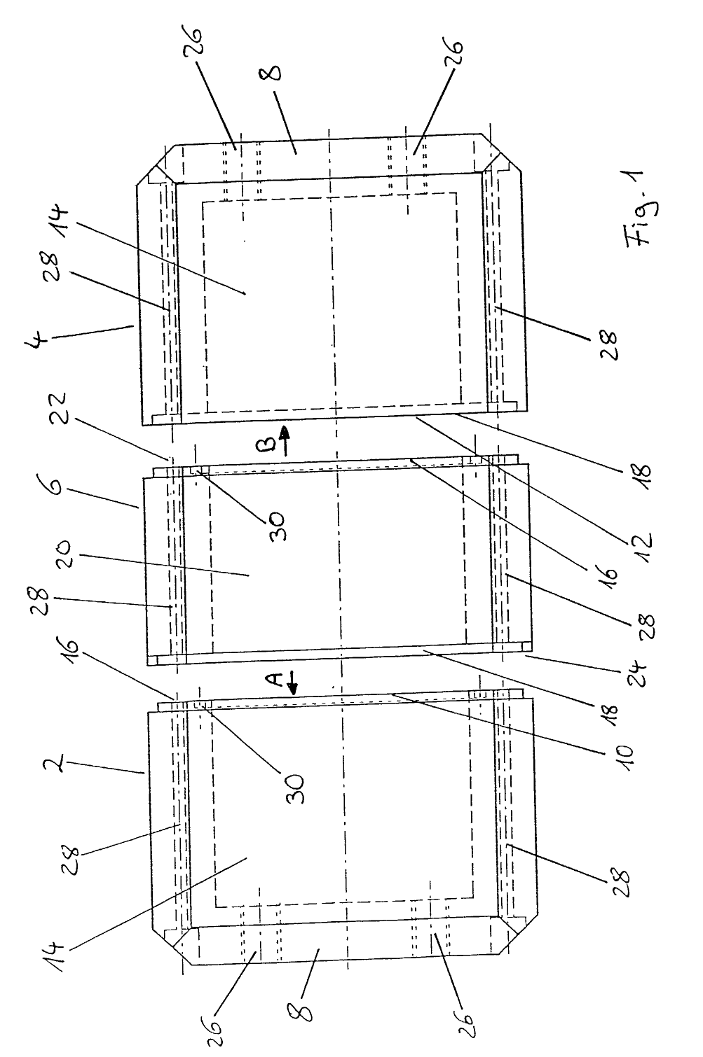

Turning to the drawings, wherein the same numerals refer to the same elements, there is shown in FIG. 1 a filter housing with two end caps 2 and 4, and an intermediate section 6. Each end cap 2 and 4 is preferably in a pot shape, that is, each has a generally oval shell, which is closed on end face 8; opposing end faces 10 and 12 are open so as to form hollow spaces 14 in the end caps. End face 10 of first end cap 2 is provided with a peripheral projection 16. Correspondingly, end face 12 of second end cap 4 is provided with a peripheral recess 18 adapted to matingly engage projection 16 of first end cap 2. Thus, end caps 2 and 4 could be joined directly, without any intermediate section, in order to obtain a very short filter housing.

Intermediate section 6 is tubular and has a generally ovoid shell with a cross-section essentially corresponding to the cross-section of end caps 2 and 4. Intermediate section 6 has a longitudinal hollow space 20 in its interior, which is open to end caps 2 and 4. This hollow space 20 forms, in common with the hollow spaces 14 in end caps 2 and 4, the interior of the filter housing, into which the filter module can be placed. A first end face 22 of intermediate section 6 is designed in the same fashion as end face 10 of first end cap 2 in that it is provided with a peripheral projection 16 to matingly engage with the recess 18 on the face 12 of second end cap 4. The opposing end face 24 of intermediate section 6 is similarly provided with a recess 18 to matingly engage projection 16 on first end cap 2. In this way, intermediate section 6 can matingly engage end caps 2 and 4, forming an enclosed filter housing.

End caps 2 and 4 are provided with fluid openings 26 in their closed end faces 8 for fluid inflow and outflow which serve the purposes of:

(a) introducing a feed into the filter housing,

(b) removing a filtrate from the filter housing, and

(c) removing a permeate from the filter housing.

As shown in the drawings, there are respectively two fluid openings 26 in each end cap 2 and 4. Alternatively, the fluid openings can be distributed in other ways on the two end caps 2 and 4, namely, all fluid openings can be provided on a single end cap. Fluid openings 26 are provided with external fittings (not shown) to make connections with hose or piping lines. Alternatively, the hose or piping lines can be directly inserted into fluid openings 26 by plugging them in, screwing them in and/or by adhesive means or by welding them to the fluid openings. In the interior of end caps 2 and 4, fluid openings 26 are provided with internal coupling elements (not shown) which are in fluid communication with corresponding coupling elements (not shown) of a filter module which has been inserted into the housing.

End caps 2 and 4 and intermediate section 6 may be provided with parallel longitudinal bores 28 along opposite sides, through which clamping means, e.g., threaded bolts may be used to pull end caps 2 and 4 together and thereby clamp intermediate section 6 therebetween. End caps 2 and 4 and intermediate section 6 are advantageously made of plastic, preferably by injection molding for purposes of cost savings in the manufacture of individual components.

FIG. 1 shows only one intermediate section 6 between the end caps 2 and 4. It is of course possible to have no intermediate section 6 between the end caps or to have multiple intermediate sections therebetween. In this manner, the length of the filter housing can be varied in order to accommodate filter modules of different lengths. When multiple intermediate sections are used, preferably all are made identically, which enables a low cost of manufacture of the filter housing to be realized, since, from a small number of standard components, filter housings of different lengths can be constructed. In addition it is possible to easily retrofit a filter housing to one of a different size to accommodate a filter module of a different length by, for example, inserting or removing intermediate sections.

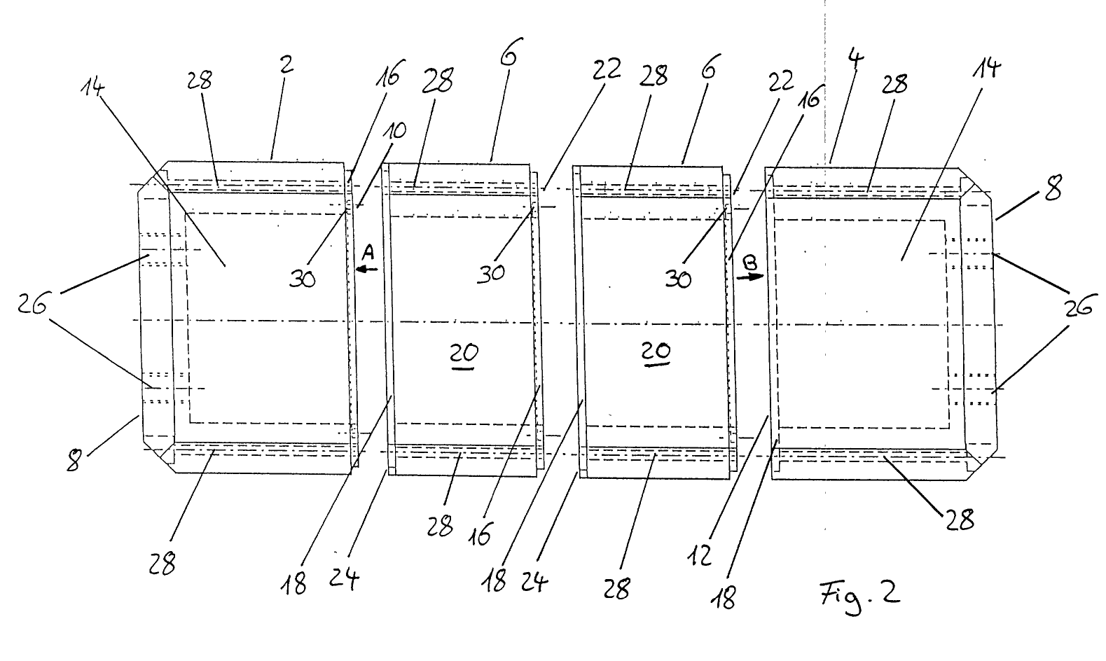

FIG. 2 shows a filter housing with two intermediate sections 6 which otherwise has the same construction as that shown in FIG. 1. By the provision of multiple intermediate sections 6 having the same kind of mating projections 16 and recesses 18 it is also possible to accommodate even longer filter modules in the housing.

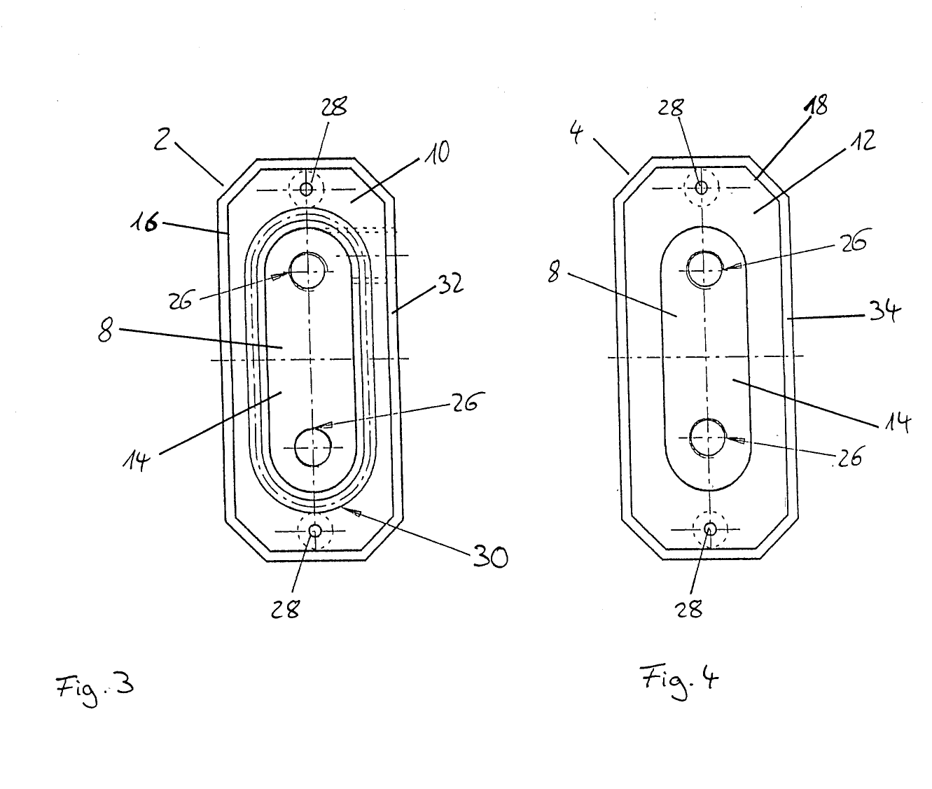

FIG. 3 shows a top view of the end face 10 of end cap 2 in the direction of the arrow A in FIGS. 1 and 2. In its interior end cap 2 has a hollow space 14, which is open all the way to the end face 10. Two fluid openings 26 are provided in the bottom 8 of end cap 2, which can be coupled with the inlet and outlet of a filter module installed in the housing. An O-ring groove 30 is provided on the end face 10, which is concentric to the edge of the hollow space 14. An O-ring is laid in O-ring groove 30 in order to seal the face 10 against the adjacent end surface 12 or 24 of second end cap 4 or of intermediate section 6, respectively. End cap 2 has a shoulder or rim 32 on its outer periphery which surrounds or defines peripheral projection 16.

The end face 22 of the intermediate section 6 is constructed identically to the end face 10 of end cap 2 in FIG. 3 so that hollow space 20 of the intermediate section 6 exhibits essentially the same cross-section as does hollow space 14 in end cap 2. Hollow spaces 14 and 20 together form an interior space of the filter housing into which a filter module can be inserted. The top view of end face 22 of an intermediate section 6 would correspond to the top view of the end face 10, with the single difference that the intermediate section 6 has no closed bottom 8. The hollow space 20 shown in FIGS. 1 and 2 is open at both ends 22 and 24.

FIG. 4 shows a top view of the end face 12 of the second end cap 4 in the direction of the arrows B of FIGS. 1 and 2. End cap 4 is provided with a hollow space 14, which is open at the end face 12. The cross-section of the hollow space 14 of the end cap 4 corresponds to the cross-section of the hollow space 14 in the end cap 2, as well as to the hollow space 20 in the intermediate section 6. The end cap 4 likewise has a closed end 8, in which fluid openings 26 may be made. On the outer periphery of the end face 12 a rim 34 is constructed which is essentially perpendicular to end face 12. This rim defines or encloses recess 18. Recess 18 has a shape which essentially corresponds to the outer contour of the engaging projection 16, so as to permit mating engagement with recess 18. The remaining area of the end face 12 is essentially constructed flat, so that an O-Ring which is laid in the O-Ring groove 30 makes a sealing contact with the remaining area.

The external shape of end caps 2 and 4 substantially conform to the outer shape of intermediate section 6, so that in assembled condition, the components form an externally smooth filter housing with the same cross section throughout its length.

Although the filter housing shown in FIGS. 1 to 4 exhibits a flat cross-section with an essentially oval plenum comprised of hollow spaces 14 and 20, the inventive filter housing may be shaped otherwise, for instance with an essentially square or circular cross-section, depending upon the shape of the filter module to be used.

As will be apparent from the foregoing, a different number of intermediate sections can be placed between the two end caps, thereby permitting the provision of filter housings of various lengths, whereby the longitudinal increments are dependent upon the length of the intermediate sections. The length of the intermediate sections is preferably so selected, that the longitudinal measure of the filter housing corresponds to the incremental length of available filter modules to be installed in the filter housing. Consideration can also be given to intermediate sections of different lengths in order to have a greater number of possible stage-lengths to make up a filter housing of given length. The intermediate sections are sealingly connected with each other as well as at the joining with the end caps, so that a filter housing sealed against the outside is created.

Advantageously, at least two intermediate sections are placed between the end caps. By means of a shorter length of the individual intermediate section, a more refined dimensioning of the ultimate length of the filter housing can be reached.

Fluid openings in at least one of the end caps permit the inflow and outflow of the media to be filtered within the filter housing. Preferably, at least three such openings are provided, namely, for the feed, for the permeate, and for the filtrate. The openings may be all located in one end cap, or they may be in both end caps. As mentioned, the fluid openings preferably have external fittings adaptable to connection with hoses or piping and internal coupling elements to place fluid inlet and outlet lines in fluid communication with the filter module.

Advantageously, male projections 16 and female recesses 18 are designed to be releasable, so that the filter housing can be easily disassembled. This makes possible an easy retrofit of the filter housing to suit a different length of filter modules. Thus, the same filter housing can be employed in different applications in accordance with the number of the intermediate sections inserted. Further, upon the placing of the components together, no thought need be given to a particular order of assembly, since all components can be connected with one another.

If a more permanent and stable connection between the components is desired, the connection between the intermediate sections, as well as between the appropriate intermediate sections and the end caps can be made by welding and/or by adhesives. In the case of plastic components, sonic welding is particularly convenient.

Fastening elements for the bonding of the intermediate sections and the end caps can be provided that are threaded through bore holes. Fastening elements can be, for example, screws or clamps, which secure the adjacent end caps and the intermediate section(s) tightly together, whereby the intermediate section(s) are held in fluid-tight compression with one another.

Preferably, two bore holes on opposite sides of the end caps and the intermediate section(s) are provided, so that a symmetrical pathway for the exertion of compressive forces is provided. In this way, the intermediate section(s) and the end caps are joined together by a substantially uniform compressive force along their peripheral connection areas.

The invention also provides a set of filter housings comprising several filter housings fabricated in accordance with the foregoing description. Preferably, the set includes at least two filter housings with a different number of inserted intermediate sections. Thus the set comprises at least two filter housings of different length. As an example, one filter housing can have two intermediate sections while another housing has three intermediate sections. One of ordinary skill will of course recognize that it is possible to have other combinations and other numbers of intermediate sections.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. A modular filter housing comprising two end caps and at least one tubular intermediate section wherein at least one of said end caps is provided with openings for fluid inflow and outflow, and wherein said end caps and said at least one intermediate section are adapted to accommodate at least one filter module and to be sealingly joined to each other.

2. The housing of claim 1 having at least two tubular intermediate sections.

3. The housing of claim 1 or 2 wherein said end caps and said intermediate sections are provided with annular peripheral projections and recesses adapted to matingly engage and disengage with each other.

4. The housing of claim 3 wherein O-rings are secured between said end caps and said intermediate sections.

5. The housing of claim 1 or 2 wherein said end caps and said intermediate sections are provided with bore holes aligned with each other.

6. The housing of claim 5 including bolts through said bore holes capable of exerting a clamping force upon said intermediate sections and said end caps.

7. The housing of claim 1 or 2 wherein said end caps and said intermediate sections are joined to each other by a method selected from welding and the application of adhesive.

8. The housing of claim 7 wherein said end caps and said intermediate sections are formed from plastic and joined to each other by sonic welding.

9. A set of at least two modular filter housings wherein each housing comprises two end caps and at least one tubular intermediate section wherein at least one of said end caps is provided with openings for fluid inflow and outflow, and wherein said end caps and said at least one intermediate section are adapted to accommodate at least one filter module and to be sealingly joined to each other and wherein at least one housing of said set has a different number of intermediate sections than the remainder of the housing(s) in said set.
